(19) United States
(12) Patent Application Publication
(10) Pub. No.: US 2020/0142647 A1
(43) Pub. Date: May 7, 2020

(54) IMAGE FORMING APPARATUS, IMAGE FORMING SYSTEM, AND NON-TRANSITORY COMPUTER READABLE RECORDING MEDIUM

(71) Applicant: KYOCERA DOCUMENT SOLUTIONS INC., Osaka (JP)

(72) Inventor: TAKATOSHI NISHIO, Osaka (JP)

(21) Appl. No.: 16/673,176

(22) Filed: Nov. 4, 2019

(30) Foreign Application Priority Data
Nov. 7, 2018 (JP) 2018-209576

(51) Int. Cl. G06F 3/12

(52) U.S. Cl. CPC G06F 3/1206; G06F 3/1248

(57) ABSTRACT

An image forming apparatus includes a controller circuit configured to receive first printable data before receiving second printable data, render the first printable data without printing during a wait time, if the second printable data is received during the wait time, start rendering and printing the second printable data in parallel with rendering of the first printable data, if the wait time passes before finishing rendering and printing the second printable data, extend the wait time until rendering and printing of the second printable data are to be finished, when rendering and printing of the second printable data are finished, print rendered part of the first printable data, and when printing of the rendered part of the first printable data is finished, and if there is un-rendered part of the first printable data, render and print the un-rendered part of the first printable data.

### CROSS-REFERENCE TO RELATED PATENT APPLICATION

This application claims the benefit of Japanese Priority Patent Application JP 2018-209576 filed Nov. 7, 2018, the entire contents of which are incorporated herein by reference.

### FIELD OF THE DISCLOSURE

The present disclosure relates to an image forming apparatus capable of rendering and printing printable data of different data formats (for example, URF data and PDF data). The present disclosure further relates to an image forming system, and a non-transitory computer readable recording medium that records an image forming program.

### BACKGROUND OF THE DISCLOSURE

There is known an image forming apparatus capable of rendering and printing printable data of different data formats (for example, URF data and PDF data).

### SUMMARY OF THE DISCLOSURE

It is desirable to increase user-friendliness of an image forming apparatus capable of rendering and printing printable data of different data formats (for example, URF data and PDF data).

According to an embodiment of the present disclosure, there is provided an image forming apparatus, including:

a controller circuit configured to

(1) receive first printable data before receiving second printable data, the first printable data being described in a data format for rendering and printing every certain amount of data separately in time series, the second printable data being described in a data format for rendering and printing simultaneously in parallel,

render the first printable data without printing during a wait time,

if the second printable data is received during the wait time,

start rendering and printing the second printable data in parallel with rendering of the first printable data,

if the wait time passes before finishing rendering and printing the second printable data, extend the wait time until rendering and printing of the second printable data are to be finished,

when rendering and printing of the second printable data are finished, print rendered part of the first printable data, and

when printing of the rendered part of the first printable data is finished, and if there is un-rendered part of the first printable data, render and print the un-rendered part of the first printable data.

According to an embodiment of the present disclosure, there is provided an image forming system, including:

an image forming apparatus; and

a relay apparatus configured to be connected to one or more terminal apparatuses via a first network, and be connected to the image forming apparatus via a second network,

the relay apparatus including a system controller circuit configured to

receive first printable data from any of the one or more terminal apparatuses, the first printable data being described in a data format for rendering and printing every certain amount of data separately in time series, receive from any of the one or more terminal apparatuses, the second printable data being described in a data format for rendering and printing simultaneously in parallel,

add a wait time to the first printable data received,

if a receipt time point of the second printable data is earlier than a receipt time point of the first printable data and if a time period between the receipt time point of the first printable data and the receipt time point of the second printable data is equal to or larger than a threshold, send the first printable data to which the wait time is added earlier and send the second printable data later to the image forming apparatus, and

if the time period between the receipt time point of the first printable data and the receipt time point of the second printable data is smaller than the threshold, and if the receipt time point of the first printable data is earlier than the receipt time point of the second printable data and if the time period between the receipt time point of the second printable data and the receipt time point of the first printable data is equal to or larger than the threshold, send the second printable data earlier and send the first printable data to which the wait time is added later to the image forming apparatus,

the image forming apparatus including a controller circuit configured to

(1) receive the first printable data before receiving the second printable data,

render the first printable data without printing during the wait time,

if the second printable data is received during the wait time,

start rendering and printing the second printable data in parallel with rendering of the first printable data,

if the wait time passes before finishing rendering and printing the second printable data, extend the wait time until rendering and printing of the second printable data are to be finished,

when rendering and printing of the second printable data are finished, print rendered part of the first printable data, and

when printing of the rendered part of the first printable data is finished, and if there is un-rendered part of the first printable data, render and print the un-rendered part of the first printable data, and

(2) receive the second printable data before receiving the first printable data,

start rendering and printing the second printable data,

if the first printable data is received during rendering and printing the second printable data,

render the first printable data without printing during the wait time in parallel with rendering and printing of the second printable data,

if the wait time passes before finishing rendering and printing the second printable data, extend the wait time until rendering and printing of the second printable data are to be finished,

when rendering and printing of the second printable data are finished, print rendered part of the first printable data, and

when printing of the rendered part of the first printable data is finished, and if there is un-rendered part of the first printable data, render and print the un-rendered part of the first printable data.

According to an embodiment of the present disclosure, there is provided a non-transitory computer readable recording medium that records an image forming program causing a controller circuit of an image forming apparatus to

(1) receive first printable data before receiving second printable data, the first printable data being described in a data format for rendering and printing every certain amount of data separately in time series, the second printable data being described in a data format for rendering and printing simultaneously in parallel,

render the first printable data without printing during a wait time,

if the second printable data is received during the wait time,

start rendering and printing the second printable data in parallel with rendering of the first printable data,

if the wait time passes before finishing rendering and printing the second printable data, extend the wait time until rendering and printing of the second printable data are to be finished,

when rendering and printing of the second printable data are finished, print rendered part of the first printable data, and

when printing of the rendered part of the first printable data is finished, and if there is un-rendered part of the first printable data, render and print the un-rendered part of the first printable data.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 schematically shows an image forming system according to an embodiment of the present disclosure;

FIG. 2 shows a hardware configuration of an image forming apparatus;

FIG. 3 shows a hardware configuration of a gateway;

FIG. 4 shows a hardware configuration of a terminal apparatus;

FIG. 5 shows a functional configuration of the image forming system;

FIG. 6 shows an operational flow of a gateway;

FIG. 7 shows a first operational flow of the image forming apparatus (which receives URF data before receiving PDF data); and

FIG. 8 shows a second operational flow of the image forming apparatus (which receives PDF data before receiving URF data).

### DETAILED DESCRIPTION OF THE EXEMPLARY EMBODIMENTS

Hereinafter, an embodiment of the present disclosure will be described with reference to the drawings.

1. Image Forming System

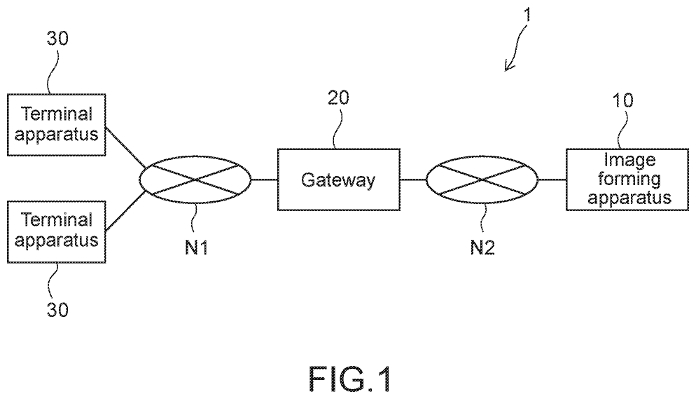

FIG. 1 schematically shows an image forming system according to an embodiment of the present disclosure.

The image forming system 1 includes the image forming apparatus 10, the relay apparatus 20, and the one or more terminal apparatuses 30. Typically, the image forming apparatus 10, the relay apparatus 20, and the one or more terminal apparatuses 30 are in one office.

Each of the one or more terminal apparatuses 30 is a personal computer, a tablet computer, a smartphone, or the like that a user (end user) uses, for example. Each of the one or more terminal apparatuses 30 sends printable data to the image forming apparatus 10 via the relay apparatus 20. Hereinafter, if it is not particularly necessary to distinguish between the one or more terminal apparatuses 30, one terminal apparatus 30 will be described and one terminal apparatus 30 will be shown in the drawings.

The relay apparatus 20 is, for example, a gateway, and will be referred to as the gateway 20 hereinafter. The gateway 20 is connected to the one or more terminal apparatuses 30 via the first network N1, and is connected to the image forming apparatus 10 via the second network N2. The gateway 20 sends (i.e., relays) the printable data received from the terminal apparatus 30 to the image forming apparatus 10.

The image forming apparatus 10 is, for example, an MFP (Multifunction Peripheral). The image forming apparatus 10 receives the printable data, which is sent by the terminal apparatus 30, from the gateway 20, and renders and prints the printable data. In the description of the present embodiment, “rendering” and “printing” executed by the image forming apparatus 10 will be divided distinctively. Specifically, “rendering” means a process of rendering printable data described in a language and generating image data (bitmap data, etc.). “Printing” means a process of forming an image on a sheet or the like on the basis of the generated image data and the like.

In the present embodiment, there are two types of printable data sent by the terminal apparatus 30, relayed by the gateway 20, and received, rendered, and printed by the image forming apparatus 10. The first printable data is described in a data format for rendering and printing every certain amount of data (for example, every page) separately in time series by the image forming apparatus 10. The first printable data is, for example, URF data. Meanwhile, the second printable data is described in a data format for rendering and printing simultaneously in parallel. The second printable data is, for example, PDF data. In the present embodiment, the first printable data will be referred to as “URF data”, and the second printable data will be referred to as “PDF data”. Simple “printable data” means the first printable data or the second printable data without distinguishing between them.

2. Hardware Configuration of Image Forming Apparatus

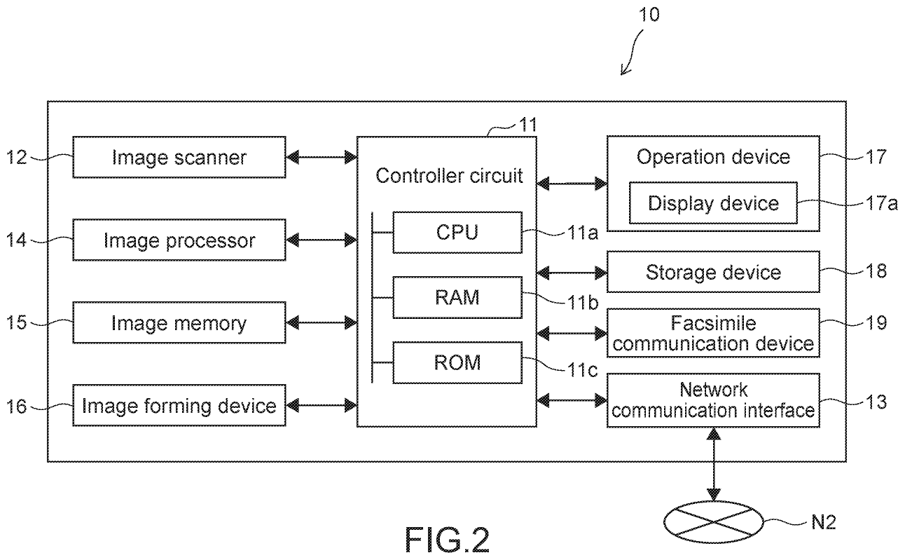

FIG. 2 shows a hardware configuration of an image forming apparatus.

The image forming apparatus 10 includes the controller circuit 11. The controller circuit 11 includes the CPU (Central Processing Unit) 11a, the RAM (Random Access Memory) 11b, the ROM (Read Only Memory) 11c, dedicated hardware circuits, and the like and performs overall operational control of the image forming apparatus 10. The CPU 11a loads information processing programs stored in the ROM 11c in the RAM 11b and executes the information processing programs. The ROM 11c is a nonvolatile memory that stores programs executed by the CPU 11a, data, and the like. The ROM 11c is an example of a non-transitory computer readable recording medium.

The controller circuit 11 is connected to the image scanner 12, the image processor 14 (including GPU (Graphics Processing Unit)), the image memory 15, the image forming device 16 (printer), the operation device 17 including the display device 17a (touch panel), the large volume nonvolatile storage device 18 such as an HDD (Hard Disk Drive) or an SSD (Solid State Drive), the facsimile communication device 19, the network communication interface 13, and the like. The controller circuit 11 performs operational control of the respective devices connected thereto and sends/receives signals and data to/from those devices.

3. Hardware Configuration of Gateway

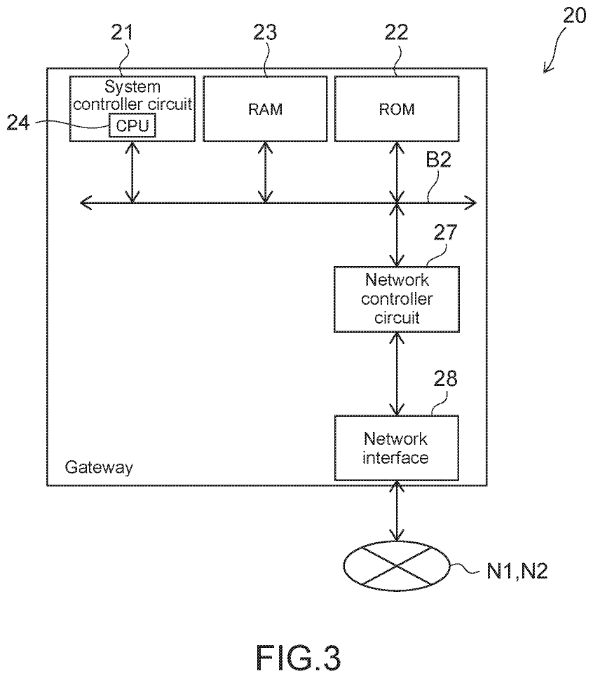

FIG. 3 shows a hardware configuration of a gateway.

The gateway 20 includes the system controller circuit 21 including the CPU 24, the ROM 22, the RAM 23, and the network controller circuit 27 to which the network interface 28 is connected. The system controller circuit 21, the ROM 22, the RAM 23, and the network controller circuit 17 are connected to each other via the bus B2.

The system controller circuit 21 includes the CPU 24. The CPU 24 of the system controller circuit 21 loads information processing programs stored in the ROM 22 in the RAM 23, and executes the information processing programs. The ROM 22 is a nonvolatile memory, and stores the information processing programs and the like executable by the CPU 24 of the system controller circuit 21.

The network controller circuit 27 controls the network interface 28. The network interface 28 is an interface for connecting to the network N. The system controller circuit 21 connects to the network N via the network interface 28. The network interface 28 is an interface of a physical layer (PHY). In a data link layer such as GMAC (Ethernet (registered trademark) MAC), the network interface 28 converts electronic signals to logical signals (bit string) (when receiving), and converts logical signals (bit string) to electronic signals (when sending).

4. Hardware Configuration of Terminal Apparatus

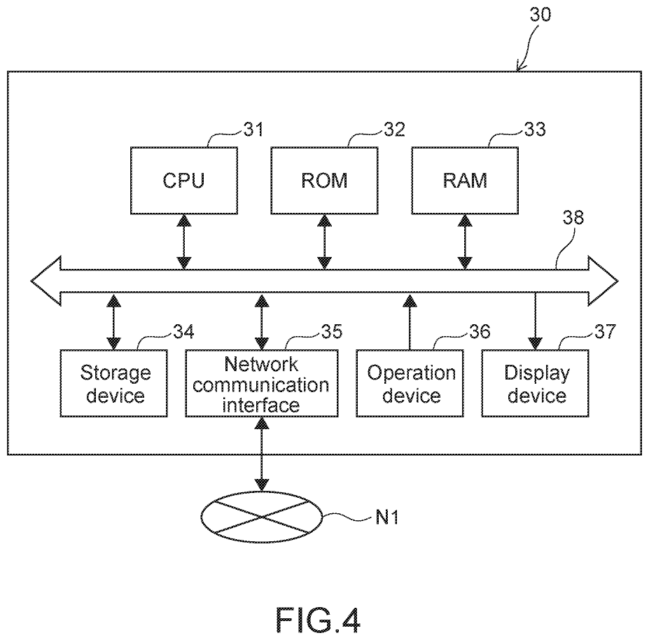

FIG. 4 shows a hardware configuration of a terminal apparatus.

The terminal apparatus 30 includes the CPU 31, the ROM 32, the RAM 33, the storage device 34, the network communication interface 35, the operation device 36, and the display device 37, and the bus 38 connecting them to each other.

The CPU 31 loads information processing programs stored in the ROM 32 in the RAM 33 and executes the information processing programs. The ROM 32 stores programs executed by the CPU 31, data, and the like nonvolatile. The ROM 32 is an example of a non-transitory computer readable recording medium.

5. Functional Configuration of Image Forming System

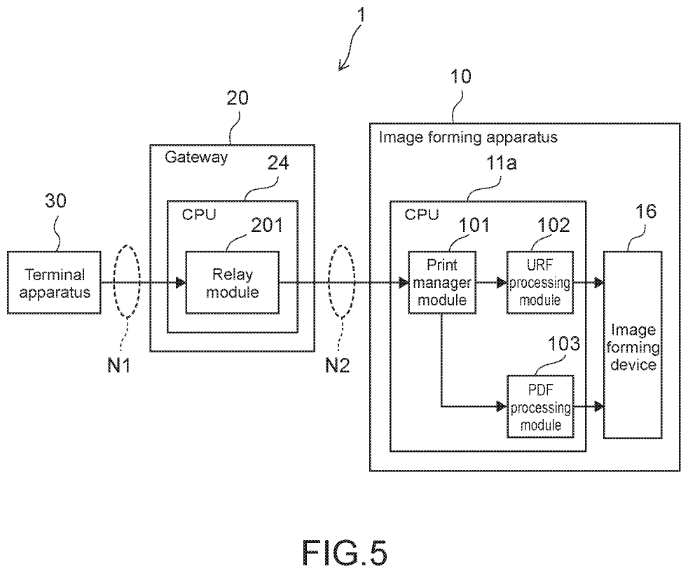

FIG. 5 shows a functional configuration of the image forming system.

In the gateway 20, the CPU 24 loads an information processing program, which is recorded in the ROM 22, in the RAM 23 and executes the information processing program to thereby operate as the relay module 201.

In the image forming apparatus 10, the CPU 11a loads an information processing program, which is recorded in the ROM 11c, in the RAM 11b and executes the information processing program to thereby operate as the print manager module 101, the URF processing module 102, and the PDF processing module 103.

The relay module 201 of the gateway 20 receives PDF data and URF data from the terminal apparatus 30 via the first network N1. The relay module 201 sends the received PDF data to the image forming apparatus 10 via the second network N2. The relay module 201 adds a wait time (described later) to the received URF data. The relay module 201 sends the URF data, to which the wait time is added, to the image forming apparatus 10 via the second network N2.

The print manager module 101 of the image forming apparatus 10 receives the PDF data and the URF data, to which the wait time is added, from the relay apparatus 20 via the second network N2. The print manager module 101 causes the URF processing module 102 to render and print the URF data, and causes the PDF processing module 103 to render and print the PDF data.

The URF processing module 102 renders the URF data, and prints the URF data by using the image forming device 16 (printer).

The PDF processing module 103 renders the PDF data, and prints the PDF data by using the image forming device 16 (printer).

6. Operational Flow of Gateway

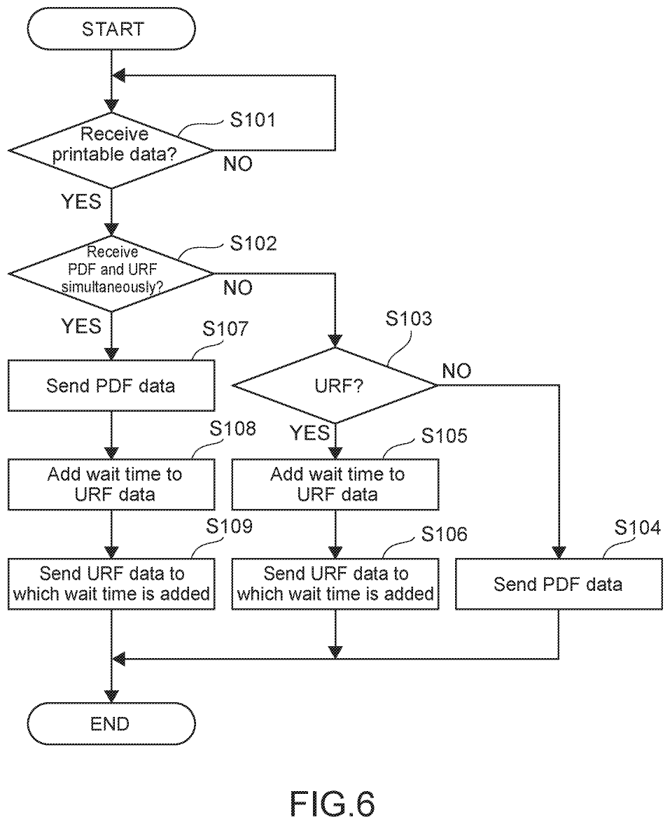

FIG. 6 shows an operational flow of a gateway.

The relay module 201 of the gateway 20 receives printable data from the terminal apparatus 30 via the first network N1 (Steps S101, S102, and S103). In the present embodiment, there are three cases of receiving printable data by the relay module 201 as follows.

In the first case, the relay module 201 receives PDF data (Steps S101: YES, S102: NO, and S103: NO). In the second case, the relay module 201 receives URF data (Steps S101: YES, S102: NO, and S103: YES). In the third case, the relay module 201 receives PDF data and URF data approximately simultaneously (Steps S101: YES, and S102: YES). In the present embodiment, “approximately simultaneously” means that a time period between a receipt time point of URF data and a receipt time point of PDF data is smaller than a threshold, where the order of the receipt time point of the URF data and the receipt time point of the PDF data are not concerned at all. The threshold is, for example, a value equal to or smaller than several seconds.

In the first case (PDF data is received), the relay module 201 sends the received PDF data to the image forming apparatus 10 via the second network N2 (Step S104).

In the second case (URF data is received), the relay module 201 adds a wait time to the received URF data (Step S105). In the present embodiment, the “wait time” is a value indicating a time length with which a user does not feel frustration even if the user waits during the wait time. Specifically, the “wait time” is a value indicating a time length between several seconds and ten and several seconds. The relay module 201 sends the URF data, to which the wait time is added, to the image forming apparatus 10 via the second network N2 (Step S106).

In the third case (PDF data and URF data are received approximately simultaneously), firstly, the relay module 201 sends the PDF data received from a terminal apparatus 30 to the image forming apparatus 10 via the second network N2 (Step S107). Next, the relay module 201 adds the wait time to the URF data received a terminal apparatus 30 (Step S108). The relay module 201 sends the URF data, to which the wait time is added, to the image forming apparatus 10 via the second network N2 (Step S109). In short, the relay module 201 sends the PDF data to the image forming apparatus 10 earlier (Step S107), and sends the URF data, to which the wait time is added, later (Step S109).

By the way, let's say that the relay module 201 of the gateway 20 receives PDF data (first case), then a time period equal to or larger than the threshold passes, and then receives URF data (second case). In this case, the relay module 201 executes the operational flow of Step S101 and thereafter twice. As a result, the relay module 201 sends the PDF data to the image forming apparatus 10 earlier (first operational flow: Step S104), and sends the URF data, to which the wait time is added, later (second operational flow: Step S106). This case will be referred to as a fourth case for convenience.

Meanwhile, let's say that the relay module 201 of the gateway 20 receives URF data (second case), then a time period equal to or larger than the threshold passes, and then receives PDF data (first case). In this case, the relay module 201 executes the operational flow of Step S101 and thereafter twice. As a result, the relay module 201 sends the URF data, to which the wait time is added, to the image forming apparatus 10 earlier (first operational flow: Step S106), and sends the PDF data later (second operational flow: Step S104). This case will be referred to as a fifth case for convenience.

7. Operational Flows of Image Forming Apparatus

Operational flows of the image forming apparatus 10 will be described separately between the two cases as follows. Firstly, there will be described a case where (1) the image forming apparatus 10 receives URF data before receiving PDF data. Secondly, there will be described a case where (2) the image forming apparatus 10 receives PDF data before receiving URF data.

Typically, it is assumed that, if the gateway 20 sends URF data before sending PDF data (fifth case), the image forming apparatus 10 receives the URF data before receiving the PDF data (aforementioned case (1)) in many cases. Similarly, it is assumed that, if the gateway 20 sends PDF data before sending URF data (third case and fourth case), the image forming apparatus 10 receives the PDF data before receiving the URF data (aforementioned case (2)) in many cases. However, the time length for sending/receiving printable data depends on the sizes and the like of PDF data and URF data. So the sending order and the receiving order may not always match. However, the present embodiment is successful irrespective of whether or not the sending order and the receiving order matches.

(1) Case where the image forming apparatus 10 receives URF data before receiving PDF data.

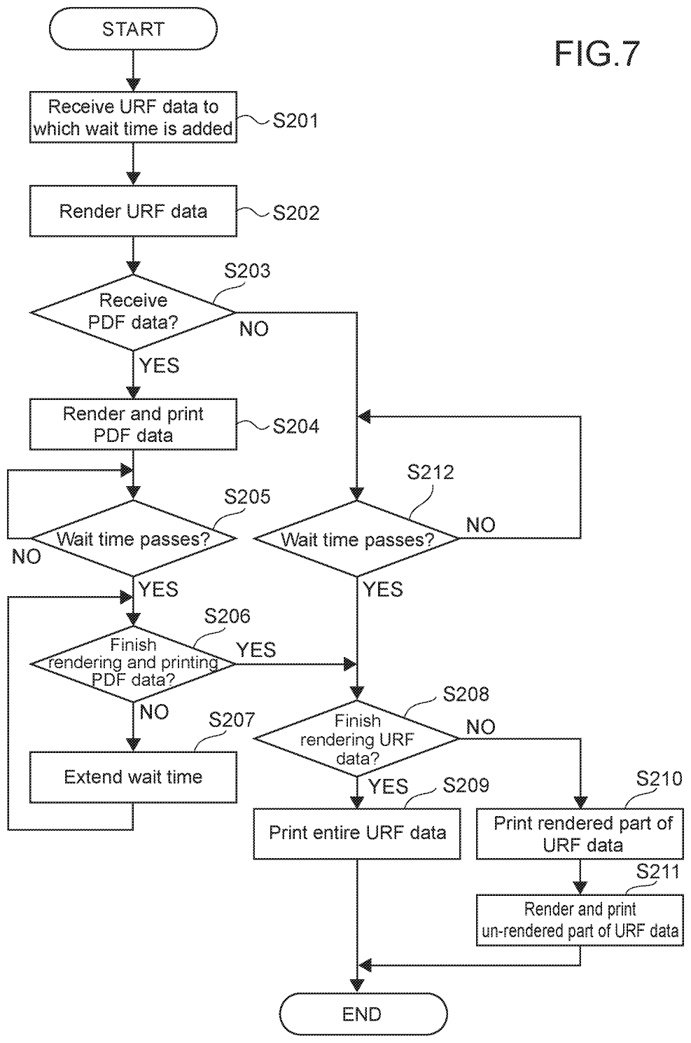

FIG. 7 shows a first operational flow of the image forming apparatus (which receives URF data before receiving PDF data).

The print manager module 101 of the image forming apparatus 10 receives the URF data, to which the wait time is added, from the relay apparatus 20 via the second network N2 (Step S201). Note that, at this time point, the print manager module 101 of the image forming apparatus 10 is yet to receive PDF data. The print manager module 101 requests the URF processing module 102 to render the URF data without printing during the received wait time (Step S202). The URF processing module 102 receives the request, and then starts rendering the URF data. The URF processing module 102 keeps on rendering the URF data without printing during the wait time.

The print manager module 101 of the image forming apparatus 10 receives PDF data from the relay apparatus 20 via the second network N2 during the wait time (Step S203, YES). Then the print manager module 101 requests the PDF processing module 103 to render the PDF data and print the PDF data by using the image forming device 16 (printer) (Step S204). The PDF processing module 103 receives the request, and then starts rendering and printing the PDF data. In short, the URF processing module 102 renders the URF data (Step S202) and the PDF processing module 103 renders and prints the PDF data (Step S204) simultaneously in parallel.

The print manager module 101 of the image forming apparatus 10 determines that the wait time passes (is finished) (Step S205, YES). Then the print manager module 101 determines whether or not the PDF processing module 103 has finished rendering and printing the PDF data (Step S206). If the print manager module 101 determines that the PDF processing module 103 has not finished rendering and printing the PDF data (Step S206, NO), the print manager module 101 extends the wait time until rendering and printing of the PDF data are to be finished. The print manager module 101 requests the URF processing module 102 to render the URF data without printing during the extended wait time (Step S207). Note that, in some cases, rendering of the URF data may have been finished before extending the wait time. However, the print manager module 101 may only has to extend the wait time until rendering and printing of the PDF data are to be finished irrespective of whether or not rendering of the URF data has been finished.

If the print manager module 101 of the image forming apparatus 10 determines that the PDF processing module 103 has finished rendering and printing the PDF data (Step S206, YES), the print manager module 101 requests the URF processing module 102 to complete rendering and printing the URF data.

If the URF processing module 102 of the image forming apparatus 10 finishes rendering the URF data during the wait time (Step S208, YES), the URF processing module 102 prints the rendered part (i.e., entire data) of the URF data by using the image forming device 16 (printer) (Step S209).

Meanwhile, if the URF processing module 102 of the image forming apparatus 10 is yet to finish rendering the URF data during the wait time (Step S208, NO), the URF processing module 102 prints the rendered part of the URF data by using the image forming device 16 (printer) (Step S210). After that, the URF processing module 102 renders and prints the un-rendered part of the URF data (Step S211). The URF processing module 102 may render the entire un-rendered part of the URF data, and then print the entire un-rendered part. Alternatively, the URF processing module 102 may render and print every certain amount of data (for example, every page) of the un-rendered part separately in time series.

By the way, after the image forming apparatus 10 received the URF data (Step S201) and started rendering (Step S202), the wait time passes (is finished) (Step S212, YES) without receiving PDF data (Step S203, NO). In this case, the URF processing module 102 of the image forming apparatus 10 may only render and print the URF data similar to Step S208 to Step S211.

(2) Case where the image forming apparatus 10 receives PDF data before receiving URF data.

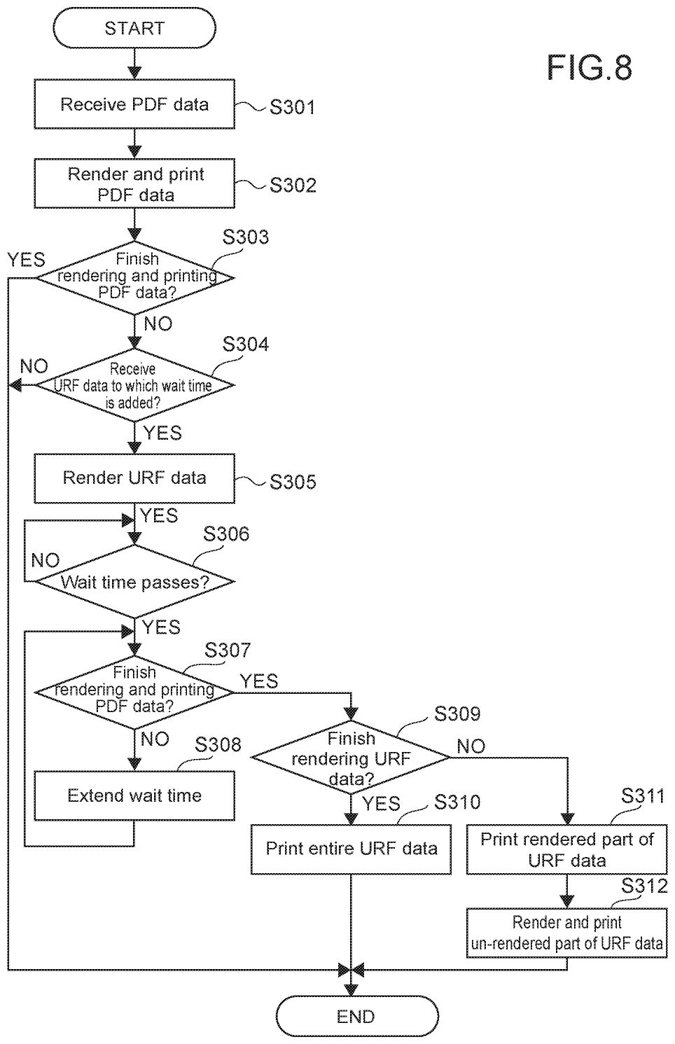

FIG. 8 shows a second operational flow of the image forming apparatus (which receives PDF data before receiving URF data).

The print manager module 101 of the image forming apparatus 10 receives the PDF data from the relay apparatus 20 via the second network N2 (Step S301). Note that, at this time point, the print manager module 101 of the image forming apparatus 10 is yet to receive URF data, to which a wait time is added. The print manager module 101 requests the PDF processing module 103 to render the PDF data and print the PDF data by using the image forming device 16 (printer) (Step S302). The PDF processing module 103 receives the request, and then starts rendering and printing the PDF data.

The print manager module 101 of the image forming apparatus 10 receives URF data, to which the wait time is added, from the relay apparatus 20 via the second network N2 (Step S304, YES) during rendering and printing the PDF data by the PDF processing module 103 (Step S303, NO). Then the print manager module 101 requests the URF processing module 102 to render the URF data without printing during the received wait time (Step S305). The URF processing module 102 receives the request, and then starts rendering the URF data. The URF processing module 102 keeps on rendering the URF data without printing during the wait time. In short, the PDF processing module 103 renders and prints the PDF data (Step S302) and the URF processing module 102 renders the URF data (Step S305) simultaneously in parallel.

The print manager module 101 of the image forming apparatus 10 determines that the wait time passes (is finished) (Step S306, YES). Then the print manager module 101 determines whether or not the PDF processing module 103 has finished rendering and printing the PDF data (Step S307). If the print manager module 101 determines that the PDF processing module 103 has not finished rendering and printing the PDF data (Step S307, NO), the print manager module 101 extends the wait time until rendering and printing of the PDF data are to be finished. The print manager module 101 requests the URF processing module 102 to render the URF data without printing during the extended wait time (Step S308). Note that, in some cases, rendering of the URF data may have been finished before extending the wait time. However, the print manager module 101 may only has to extend the wait time until rendering and printing of the PDF data are to be finished irrespective of whether or not rendering of the URF data has been finished.

If the print manager module 101 of the image forming apparatus 10 determines that the PDF processing module 103 has finished rendering and printing the PDF data (Step S307, YES), the print manager module 101 requests the URF processing module 102 to complete rendering and printing the URF data.

If the URF processing module 102 of the image forming apparatus 10 finishes rendering the URF data during the wait time (Step S309, YES), the URF processing module 102 prints the rendered part (i.e., entire data) of the URF data by using the image forming device 16 (printer) (Step S310).

Meanwhile, if the URF processing module 102 of the image forming apparatus 10 is yet to finish rendering the URF data during the wait time (Step S309, NO), the URF processing module 102 prints the rendered part of the URF data by using the image forming device 16 (printer) (Step S311). After that, the URF processing module 102 renders and prints the un-rendered part of the URF data (Step S312). The URF processing module 102 may render the entire un-rendered part of the URF data, and then print the entire un-rendered part. Alternatively, the URF processing module 102 may render and print every certain amount of data (for example, every page) of the un-rendered part separately in time series.

8. Conclusion

URF data is described in a data format for rendering and printing every certain amount of data separately in time series. Meanwhile, PDF data is described in a data format for rendering and printing simultaneously in parallel.

Let's say that an image forming apparatus receives URF data before receiving PDF data. In this case, typically, the image forming apparatus renders and prints every certain amount of data (typically, every page) of the URF data separately in time series. After that, the image forming apparatus renders and prints the PDF data. As a result, a user may feel that it takes a long time (from print start time to print finish time) to print the URF data. As a result, the user may feel that the print start time for the PDF data is late (as a result, print finish time is also late).

(1) To the contrary, according to the present embodiment, if the image forming apparatus 10 receives URF data, to which the wait time is added, (Step S201), the image forming apparatus 10 renders the URF data without printing during the wait time (Step S202). If the image forming apparatus 10 receives PDF data during the wait time (Step S203, YES), the image forming apparatus 10 renders and prints the PDF data received later (Step S204) before printing the URF data received earlier. As a result, the image forming apparatus 10 is capable of starting (and also finishing, as a result) printing the PDF data earlier, even if the image forming apparatus 10 received the PDF data after receiving the URF data. The image forming apparatus 10 extends the wait time until rendering and printing of the PDF data are to be finished. The image forming apparatus 10 renders the URF data without printing during the extended wait time (Step S207). As a result, the image forming apparatus 10 can keep on rendering the URF data as much as possible during printing the PDF data by using the image forming device 16 (printer) (i.e., during time in which the image forming apparatus 10 cannot print the URF data). When the image forming apparatus 10 finishes rendering and printing the PDF data (Step S206, YES), the image forming apparatus 10 prints the rendered part of the URF data (Steps S209 and S210). As a result, a user may feel that it takes a shorter time (from print start time to print finish time) to print the URF data.

Meanwhile, let's say that an image forming apparatus receives PDF data before receiving URF data. In this case, typically, the image forming apparatus renders and prints PDF data. After that, the image forming apparatus renders and prints every certain amount of data (typically, every page) of the URF data separately in time series. As a result, a user may feel that the print start time and the print finish time for the PDF data are as usual. However, the user may feel that it takes a long time (from print start time to print finish time) to print the URF data.

(2) To the contrary, according to the present embodiment, if the image forming apparatus 10 receives PDF data (Step S301), the image forming apparatus starts rendering and printing the PDF data (Step S302). If the image forming apparatus 10 receives the URF data, to which the wait time is added, (Step S304, YES), during rendering and printing the PDF data (Step S303, NO), the image forming apparatus 10 renders the URF data without printing during the wait time (Step S305). The image forming apparatus 10 extends the wait time until rendering and printing of the PDF data are to be finished. The image forming apparatus 10 renders the URF data without printing during the extended wait time (Step S308). As a result, the image forming apparatus 10 can keep on rendering the URF data as much as possible during printing the PDF data by using the image forming device 16 (printer) (i.e., during time in which the image forming apparatus 10 cannot print the URF data). When the image forming apparatus 10 finishes rendering and printing the PDF data (Step S307, YES), the image forming apparatus 10 prints the rendered part of the URF data (Steps S310 and S311). As a result, a user may feel that it takes a shorter time (from print start time to print finish time) to print the URF data.

Further, according to the present embodiment, if the gateway 20 receives PDF data and URF data approximately simultaneously, even if the gateway 20 receives the URF data earlier actually, the gateway 20 sends the PDF data earlier to the image forming apparatus 10 (Step S107) and sends the URF data, to which the wait time is added, later (Step S109). As a result, if the image forming apparatus 10 receives PDF data earlier than URF data (Step S301), the image forming apparatus starts rendering and printing the PDF data (Step S302). As a result, the image forming apparatus 10 is capable of starting (and also finishing, as a result) printing the PDF data earlier, even if the gateway 20 received the PDF data after receiving the URF data. After that, if the image forming apparatus 10 receives the URF data, to which the wait time is added, (Step S304, YES), during rendering and printing the PDF data (Step S303, NO), the image forming apparatus 10 renders the URF data without printing during the wait time (Step S305). The image forming apparatus 10 extends the wait time until rendering and printing of the PDF data are to be finished. The image forming apparatus 10 renders the URF data without printing during the extended wait time (Step S308). As a result, the image forming apparatus 10 can keep on rendering the URF data as much as possible during printing the PDF data by using the image forming device 16 (printer) (i.e., during time in which the image forming apparatus 10 cannot print the URF data). When the image forming apparatus 10 finishes rendering and printing the PDF data (Step S307, YES), the image forming apparatus 10 prints the rendered part of the URF data (Steps S310 and S311). As a result, a user may feel that it takes a shorter time (from print start time to print finish time) to print the URF data.

It should be understood by those skilled in the art that various modifications, combinations, sub-combinations and alterations may occur depending on design requirements and other factors insofar as they are within the scope of the appended claims or the equivalents thereof

What is claimed is:

1. An image forming apparatus, comprising:
a controller circuit configured to
(1) receive first printable data before receiving second printable data, the first printable data being described in a data format for rendering and printing every certain amount of data separately in time series, the second printable data being described in a data format for rendering and printing simultaneously in parallel,
render the first printable data without printing during a wait time,
if the second printable data is received during the wait time,
start rendering and printing the second printable data in parallel with rendering of the first printable data,
if the wait time passes before finishing rendering and printing the second printable data, extend the wait time until rendering and printing of the second printable data are to be finished,
when rendering and printing of the second printable data are finished, print rendered part of the first printable data, and
when printing of the rendered part of the first printable data is finished, and if there is un-rendered part of the first printable data, render and print the un-rendered part of the first printable data.

2. The image forming apparatus according to claim 1, wherein
the controller circuit is configured to
(2) receive the second printable data before receiving the first printable data,
start rendering and printing the second printable data,
if the first printable data is received during rendering and printing the second printable data,
render the first printable data without printing during the wait time in parallel with rendering and printing of the second printable data,
if the wait time passes before finishing rendering and printing the second printable data, extend the wait time until rendering and printing of the second printable data are to be finished,
when rendering and printing of the second printable data are finished, print rendered part of the first printable data, and
when printing of the rendered part of the first printable data is finished, and if there is un-rendered part of the first printable data, render and print the un-rendered part of the first printable data.

3. The image forming apparatus according to claim 1, wherein
the first printable data is URF data, and
the second printable data is PDF data.

4. The image forming apparatus according to claim 2, wherein
the first printable data is URF data, and
the second printable data is PDF data.

5. An image forming system, comprising:
an image forming apparatus; and
a relay apparatus configured to be connected to one or more terminal apparatuses via a first network, and be connected to the image forming apparatus via a second network,
the relay apparatus including a system controller circuit configured to
receive first printable data from any of the one or more terminal apparatuses, the first printable data being described in a data format for rendering and printing every certain amount of data separately in time series,
receive from any of the one or more terminal apparatuses, the second printable data being described in a data format for rendering and printing simultaneously in parallel,
add a wait time to the first printable data received,
if a receipt time point of the second printable data is earlier than a receipt time point of the first printable data and if a time period between the receipt time point of the first printable data and the receipt time point of the second printable data is equal to or larger than a threshold, send the first printable data to which the wait time is added earlier and send the second printable data later to the image forming apparatus, and
if the time period between the receipt time point of the first printable data and the receipt time point of the second printable data is smaller than the threshold, and if the receipt time point of the first printable data is earlier than the receipt time point of the second printable data and if the time period between the receipt time point of the second printable data and the receipt time point of the first printable data is equal to or larger than the threshold, send the second printable data earlier and send the first printable data to which the wait time is added later to the image forming apparatus,
the image forming apparatus including a controller circuit configured to (1) receive the first printable data before receiving the second printable data, render the first printable data without printing during the wait time,
if the second printable data is received during the wait time,
start rendering and printing the second printable data in parallel with rendering of the first printable data,
if the wait time passes before finishing rendering and printing the second printable data, extend the wait time until rendering and printing of the second printable data are to be finished,
when rendering and printing of the second printable data are finished, print rendered part of the first printable data, and
when printing of the rendered part of the first printable data is finished, and if there is un-rendered part of the first printable data, render and print the un-rendered part of the first printable data, and
(2) receive the second printable data before receiving the first printable data,
start rendering and printing the second printable data,
if the first printable data is received during rendering and printing the second printable data,
render the first printable data without printing during the wait time in parallel with rendering and printing of the second printable data,
if the wait time passes before finishing rendering and printing the second printable data, extend the wait time until rendering and printing of the second printable data are to be finished,
when rendering and printing of the second printable data are finished, print rendered part of the first printable data, and
when printing of the rendered part of the first printable data is finished, and if there is un-rendered part of the first printable data, render and print the un-rendered part of the first printable data.

6. A non-transitory computer readable recording medium that records an image forming program causing a controller circuit of an image forming apparatus to
(1) receive first printable data before receiving second printable data, the first printable data being described in a data format for rendering and printing every certain amount of data separately in time series, the second printable data being described in a data format for rendering and printing simultaneously in parallel,
render the first printable data without printing during a wait time,
if the second printable data is received during the wait time,
start rendering and printing the second printable data in parallel with rendering of the first printable data,
if the wait time passes before finishing rendering and printing the second printable data, extend the wait time until rendering and printing of the second printable data are to be finished,
when rendering and printing of the second printable data are finished, print rendered part of the first printable data, and
when printing of the rendered part of the first printable data is finished, and if there is un-rendered part of the first printable data, render and print the un-rendered part of the first printable data.
